(19) United States
(12) Patent Application Publication
(10) Pub. No.: US 2016/0059613 A1
(43) Pub. Date: Mar. 3, 2016

(54) Items for Stationary from Eco Friendly Materials and Resins

(71) Applicant: Shantu Patel, Carlsbad, CA (US)

(72) Inventor: Shantu Patel, Carlsbad, CA (US)

(21) Appl. No.: 14/500,491

(22) Filed: Sep. 29, 2014

Related U.S. Application Data
(60) Provisional application No. 62/045,456, filed on Sep. 3, 2014.

(51) Int. Cl. B42F 13/00

(52) U.S. Cl. CPC B42F 13/0013

(57) ABSTRACT

Items for stationary from eco friendly materials and resins include a ring binder having a cover that includes ring binder having a cover that includes cardboard; and one or two bioplastic sheet that entirely covers the cardboard, the bioplastic including at least one of: polylactic acid (PLA), cellulose based PH, polycaprolate (PCL), polybutyleneadipatetetephathalate (PBT), polyhydroxyalkanoate (PHA), green polyethylene (GPE), or green polyethylene terephthalate (GPET). The inner sheet may be colored or opaque and the outer sheet may be translucent. The ring mechanism may be on the spine or on the inner back cover. Methods include laying the bioplastic sheet over the cover so that the sheet cover the cardboard.

### REFERENCE TO PRIORITY DOCUMENT

This application claims the benefit of priority of co-pending U.S. Provisional Patent Application Ser. No. 62/045,456, entitled “STATIONARY ITEMS FROM ECO FRIENDLY MATERIALS AND RESINS” filed Sep. 3, 2014. The filing dates and subject matter of the above-noted application is incorporated by reference in its entirety by reference thereto.

### BACKGROUND

The present disclosure generally relates to eco friendly stationary items, and more specifically to ring binders, sheet protector and dividers for filing paper and organizing documents, made from bioplastic resins.

Binders are ideal tools for keeping papers and folders organized. Many binders are built around a simple concept involving a piece of cardboard enclosed in plastic, with a metal lock-ring bar (usually two, three or four rings) affixed to back of the covers, mid spine or left lateral margin, with or without a lever, that open and close the rings. There are several variations, with some binders having more rings, with variable size, width, and shape. As a standard, there are several sizes of binders (based on the lock-ring size): ½ inch, 1 inch, 1½ inch, 2 inch and 3 inch and up to 6 to 8 inches, holding letter size documents. In addition to different sizes, there are also several styles to choose from and various colors.

Existing materials such as polypropylene (PP), polyvinyl chloride (PVC) and cardboard are traditional materials used to make ring binders, sheet protector and dividers at low cost, and are used in various industries for filing or for holding sheets of paper or organize documents. Traditional binders may made of a rigid cardboard sheet covered by vinylor polypropylene.

It would be desirable to have a stationary items from eco friendly materials and resins.

### SUMMARY

In one aspect, a device includes a ring binder having a cover that includes cardboard; and a first bioplastic sheet that entirely covers the cardboard, the bioplastic including at least one of: polylactic acid (PLA), cellulose based PH, polycaprolate (PCL), polybutyleneadipatetetephathalate (PBT), polyhydroxyalkanoate (PHA), green polyethylene (GPE), PDLA (poly-D-lactide), or green polyethylene terephthalate (GPET).

In another aspect, a device includes a ring binder having a cover that includes cardboard; a first, colored or opaque bioplastic sheet that entirely covers the cover and includes a bioplastic resin containing a plasticizer and at least one of: polylactic acid (PLA), cellulose based PH, Polycaprolate (PCL), Polybutyleneadipatetetephathalate (PBT), Polyhydroxyalkanoate (PHA), green polyethylene (GPE), or green polyethylene terephthalate (GPET); a second, translucent bioplastic sheet that includes the bioplastic resin; a middle spine; a plurality of degradable rings mounted on the middle spine or left lateral margin of back cover, so that the cover folds against the rings. A divider for the binder that includes the bioplastic resin; and a sheet protector that includes the bioplastic resin that has a left lateral tab and a plurality of apertures in the tab that align with the rings.

In yet another aspect, a method of making a degradable ring binder includes providing a continuous piece of cardboard; providing a first, clear or translucent substantially bioplastic sheet, the bioplastic including a plasticizer and at least one of: polylactic acid (PLA), cellulose based PH, Polycaprolate (PCL), Polybutyleneadipatetetephathalate (PBT), polyhydroxyalkanoate (PHA), green polyethylene (GPE), or green polyethylene terephthalate (GPET); coating the cardboard with a thin layer of adhesive that will hold the bioplastic; laying the bioplastic sheet over the cardboard so that the sheet covers the cardboard, thereby providing a binding cover; providing a degradable ring mechanism; and attaching the ring mechanism to the bind cover.

### BRIEF DESCRIPTION OF THE DRAWINGS

FIG. 1A depicts an embodiment of a binder in an open position;

FIG. 1B depicts the embodiment of FIG. 1A in a closed position;

FIG. 2 depicts a cross section of a wall of the embodiment of FIG. 1A;

FIG. 3 depicts an embodiment of a sheet;

FIG. 4 depicts an embodiment of a divider;

FIG. 5A depicts an embodiment of binder with ring mechanism on the spine; and

FIG. 5B depicts an embodiment of binder with ring mechanism on the cover;

FIG. 6 depicts the ring mechanism.

### DETAILED DESCRIPTION

Several embodiments, which can be used in industry are hereby described in detail with reference to the drawings. Further embodiments, features and advantages will become apparent from the ensuing description, or may be learned without undue experimentation. The figures are not necessarily drawn to scale, except where otherwise indicated.

An embodiment generally provides stationary items such as ring binders, sheet protectors and dividers that are made from bioplastic resins, to be used for filing paper and organizing documents.

Embodiments of bio resins are from a renewable resources, and may replace the non-renewable, fossil and petroleum based plastics to offer environmental advantages. Bioplastic resins are derived from plants like corn, cellulose and sugarcane. Plastic has detrimental effects on the environment and can be replaced by product made from bio resin. Bioresins are from a renewable resource, use less energy, cause less carbon dioxide emission, and have a smaller carbon footprint. Some of these resins are compostable and lead to zero waste, which can be an added advantage.

Embodiments may utilize bioplastics or “Eco Friendly Materials” that include (in any proportion) or substantially consist of (more than half by volume): polylactic acid (PLA), polyhydroxyalkanoate (PHA), cellulose based (PH), Polybutyleneadipatetetephathalate (PBT), Polycaprolate (PCL), green polyethylene (GPE), and green polyethylene terephthalate (GPET or GPETE). PLA and PHA are derived by plant fermentation. PH is cellulose based. PBT and PCL are obtained from corn and cellulose. GPE and GPET/GPETE are obtained from sugarcane. The Eco Friendly Materials can be converted into biaxial oriented films or sheets with excellent optics, excellent machinability, twist, tear and dead fold properties.

TABLE 1 differentiates the end of life properties and degradability of various bio resins. Bio resins are opaque or translucent, come from a known resource, may be biodegradable at the end of their lives, and may be used in this application.

TABLE 1

| | | | Opaque | | Biodegradeable | Used in this |
|---|---|---|---|---|---|---|
| | Bio resin | Abbreveation | Transclucent | Resourse | end of life | application |
| 1 | Polybutyleneadipate- | PBT | Opaque | Starch | yes | yes |
| | tetephthalate | | | | | |
| 2 | Polycaprolate/starch | PCL | Opaque | Starch | yes | yes |
| 3 | Polylactic Acid | PLA | Transclucent | Corn | yes | yes |
| 4 | Poly 3 Hydrobutyrate | PHA | Opaque | Corn, Starch | Yes | yes |
| 5 | Polyamide | PA | Opaque | Vegetable oil | yes | no |
| 6 | Bio polyethelene | GPE | Transclucent | Sugarcane | no | yes |
| 7 | Bio Polyethelene | GPET, GPETE | Transclucent | Sugarcane | no | yes |
| | tetephthalate | | | | | |
| 8 | Cellulose Based | PH | Transclucent | Cellulose | yes | yes |
| 9 | Polyhydroxybutyrate | PHV | Opaque | Starch | yes | no |
| | co valarate | | | | | |
| 10 | Polybutylene Succinate | PBS | Opaque | Starch | yes | no |
| 11 | Polybutylene adipate | PBSA | Opaque | Starch | yes | no |

TABLE 2 differentiates Eco Friendly Materials from other materials used to make stationary products.

TABLE 2

| | PLA | PH | PBT | PCL | PHA | GPE |
|---|---|---|---|---|---|---|
| Ring Binder | yes | yes | yes | yes | yes | yes |
| Sheet protectors | yes | yes | no | yes | no | yes |
| Dividers | yes | yes | yes | yes | yes | yes |
| Biodegradable | yes | yes | yes | yes | yes | no |

An embodiment may include binders made of a rigid cardboard sheet, such as virgin or recycled material. An outer binder cover may include bioresins such as PLA, PDLA, PHA, PCL, PH, PBT, and GPET. The binder cover may be made from cardboard and the bio resin mentioned. Embodiments may include sheet protectors made from PLA, GPE, GPET, PCL and PH cellulose based bioresin. Embodiments may include dividers made from Eco Friendly bioresins. The products namely binder, sheet protectors and divider that are made from PLA, PHA, PCL, PH, PBT, and any paper in the binder are, all elements that are compostable. Thus if disposed properly in an industrial composter, there can lead to zero waste and can be diverted from land fields. Embodiments made from GPE, or GPET might not generally be biodegradable. Embodiments with metal rings may degrade but at a much slower pace. A ringed metal part may be fixed or removable, thereby making the entire device recyclable. Embodiments of bioplastic rings may be generally D shaped or ring shaped. An embodiment with a bioplastic ring mechanism may degrade faster than a metal embodiment. The compostable binder, sheets, divider and ring may be placed after use into an industrial composter, and may degrade in three to six months. Embodiments of binders, sheet protectors and dividers can range in size, thickness or shape. An example common size may generally hold letter or legal size (8.5 by 11 or 14 inches) paper or sheets. Embodiments of the ring binder outer cover may be of any color and can be dual layered with and outer clear layer. The divider may be clear or of any color, with or without a tab with holes that fit the ring binder. The sheet protector may be translucent with a left lateral extension tab that has holes in which fit the rings of the binder and is top or lateral loaded. The thickness of the film or sheet that makes the sheet protector, dividers and outer cover of the binder can range from 1 mil to 25 mil in thickness. The binder outer cover, sheet protector and dividers can be translucent, non-glare and/or any color.

A ring binder mechanism may include a ring metal device found on the spines of standard loose leaf binders. These binder parts may be either metal or bioplastic, in a variety of colors and sizes. D shaped retainer rings may be spring-loaded, and can also be secured by a lever or other securing systems. Embodiments of a ring mechanism may include a spine with a one or more rings to hold papers. A spine may include a bioplastic resin with an added plasticizer. The rings may be metal or bioplastic. Embodiments of a bio resin for a ring binder mechanism may include PLA, PHA, PCL, PBH, PH, PBT, GPE, or GPET. Embodiments of various parts such as the spine may include a plasticizer.

Embodiments of binders and sheet protectors may be for letter size, legal size, or other sizes.

To make an embodiment, binders may begin as a single, continuous piece of cardboard that may be from a recycled or virgin source of degradable paper. An embodiment may be approximately 4-6 feet in length and cut into the length of the spine and front and back cover. This measured cardboard piece may be coated in a thin layer of adhesive that will hold the bio plastic cover on. The board may be laid on top of a clear or translucent sheet, and a second colored, opaque, or translucent bioplastic sheet. The pocket sheet or more than one pocket then pocket sheets, may be laid over the top, enclosing the cardboard. A machine (similar to a sewing machine) with heated filaments may press and cut the sheets of bioplastic around their edges, creating a permanent peripheral seal and a foldable seal around the middle spine. A series of rollers may press over the top of the board, smoothing out the plastic and ensuring it has a strong seal. Next, the binder rings, metal or bioplastic may be added by mechanically mounting the ring apparatus. The rings may come as a single-piece construction consisting of a bioplastic or metal bar, with the rings attached on top. The bar may be mounted to mid spine or the left lateral margin of the back of the cover of the binder using a series of pins. A machine may press the pins into place to permanently attach the bar.

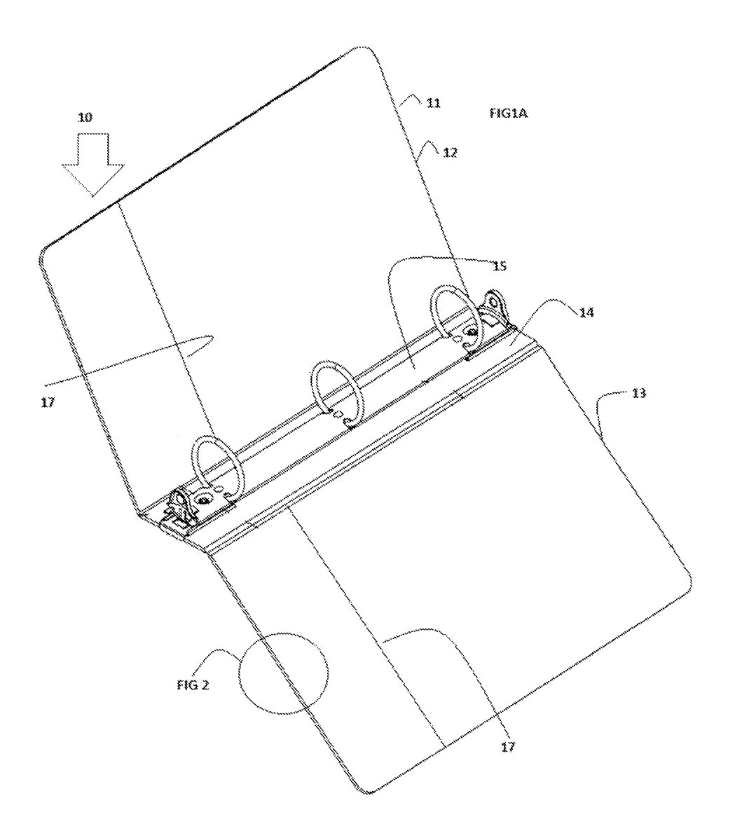

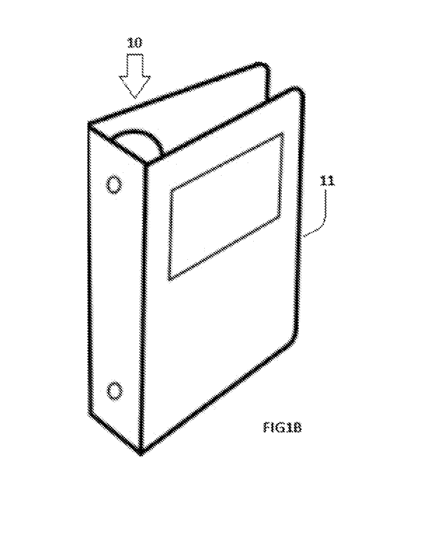

As depicted in the embodiment of FIGS. 1A and 1B, a ring binder 10 may include a cover 11 that includes a cardboard from virgin or recycled material. The cover may have a front 12, middle spine 14 and a back 13. Metal or bioplastic ring binder rings 15 may be mounted on the middle spine 14. The binder rings 15 may be fixed or removable. The cover front 12 and back 13 may each have pockets 17, one or more on the inner lower edge of the cover.

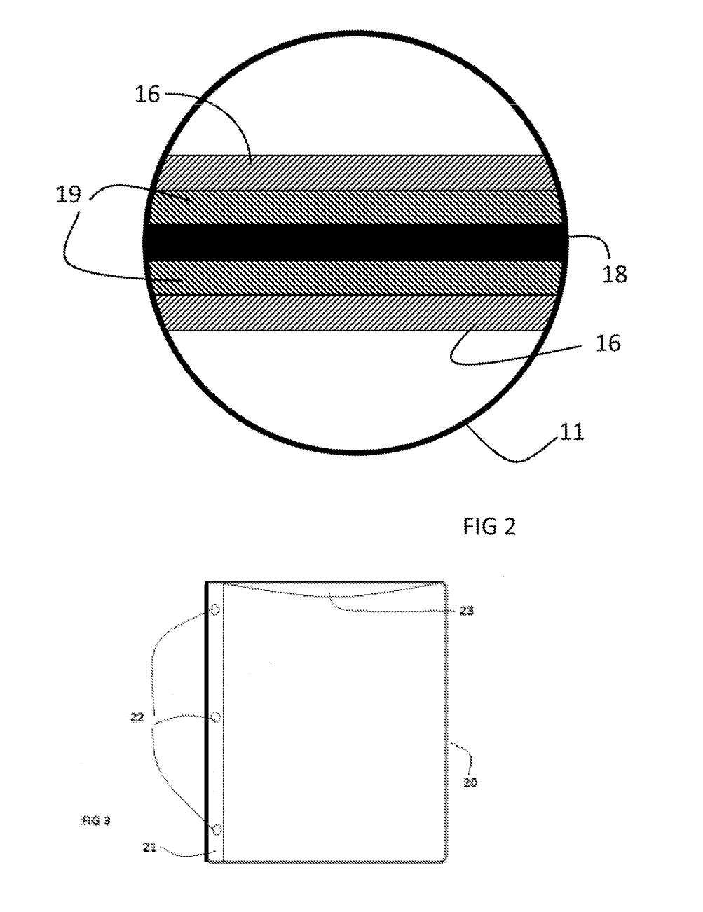

As depicted in the embodiment of FIG. 2, a cover 11 may include cardboard 18 from virgin or recycled material, covered by a colored or opaque first bioplastic sheet 19, which is covered in turn by translucent and non glare second bioplastic sheet 16. The cardboard 18 may have layers of bioplastic sheets 19, 16 above and below so that the cardboard is completely covered on both sides. The sheets 16 may generally be translucent and non glare. The sheets 19 may be colored or opaque.

As depicted in the embodiment of FIG. 3, a sheet protector 20 be made from the Eco Friendly resins mentioned above. An embodiment of a sheet protector 20 may have a left lateral tab 21, which has three or more holes or apertures 22 which fit in the metal or bioplastic rings. Sheet protector 20 may also have a top loaded opening 23 through which a paper or card or photo can be loaded into the sheet protector. Embodiments of a sheet protector 20 may have several smaller pockets to be loaded with several cards, photos or business cards.

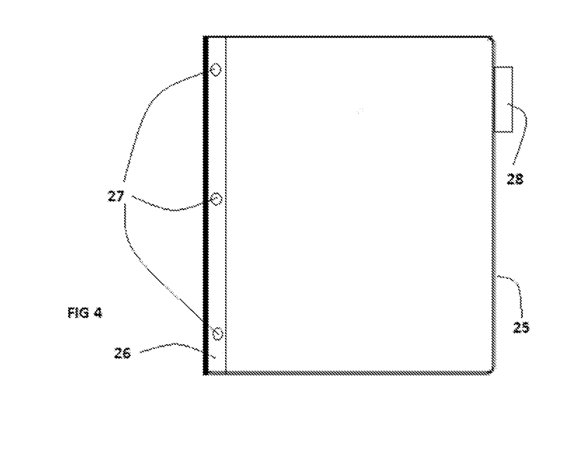

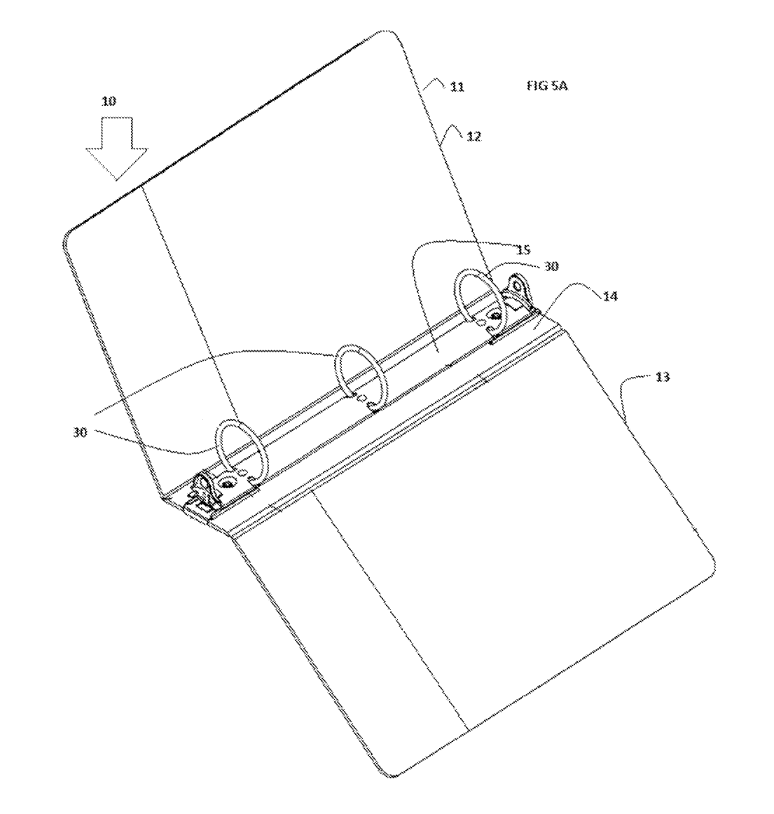

As depicted in the embodiment of FIG. 4, a divider 25 may be made from the Eco Friendly resins mentioned above, and have a left lateral tab 26, which has three or more holes or apertures 27 which fit in the metal or bioplastic rings. The divider may have a tab 28 on the right margin, and the location, shape and size may vary.

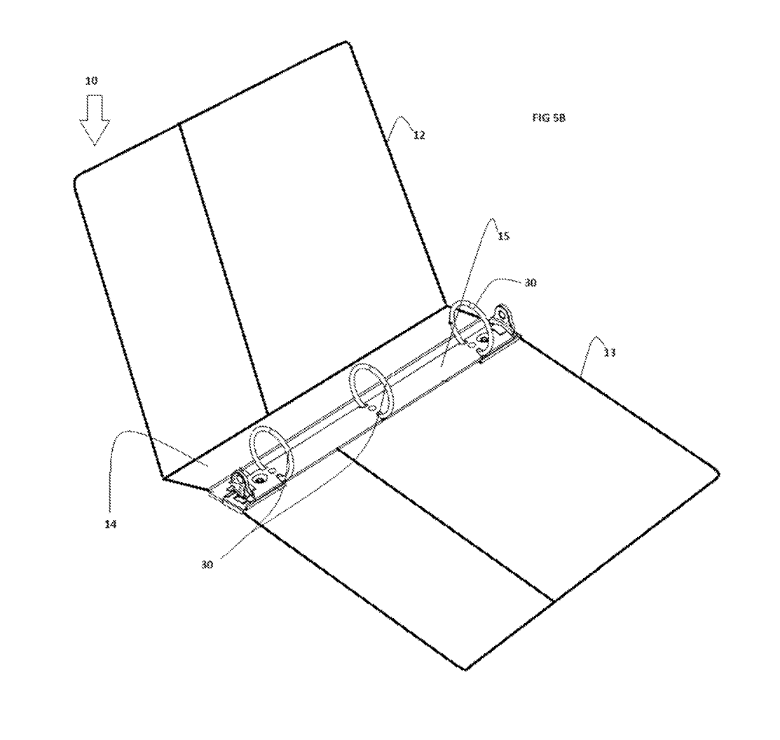

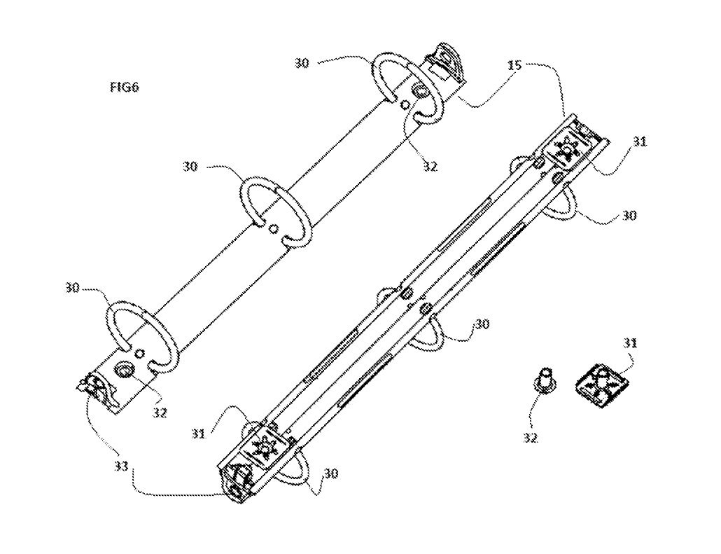

As depicted in the embodiment of FIG. 5A, a ring binder 10 may include a cover 11 having a front 12, a back 13, and a middle spine 14, and a ring mechanism 15 fixed to the middle spine 14. As depicted in FIG. 6 the ring mechanism 15 may include rings 30, mounting posts 31 to hold the spine 14 to the ring mechanism 15, rivets 32 to fix the rings 30 to the spine 14, and a lever 33 that opens and closes the rings 30. The binder rings 15 may be fixed or removable. The rings 30 retain loose-leaf pages on the ring mechanism 15 while the lever 33 operates to open and close the rings 30 so that pages may be added or removed. When closed, the front 12 and back 13 will fold against the sides of the rings 30.

As depicted in the embodiment of FIG. 5B, a ring binder 10 may include a front 12, a back 13, and a ring mechanism 15 fixed to the back 13 of the cover. The binder 10 will fold closed so that the middle spine 14 folds up against the rings 30 and the front 12 folds down over the top of the rings 30. The embodiments of FIG. 5A and 5B may tend to fold into a triangle with the rings at the bottom of the triangle. In the embodiment of FIG. 5A, the rings are attached at the bottom (the spine) and open up toward the top of the triangle. In the embodiment of FIG. 5B, the rings are attached to the inside of the back of the cover (the right side) and open up toward the front cover of the binder.

While this specification contains many specifics, these should not be construed as limitations on the scope of an invention that is claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Although embodiments of various methods and devices are described herein in detail with reference to certain versions, it should be appreciated that other versions, embodiments, methods of use, and combinations thereof are also possible. Therefore the spirit and scope of the appended claims should not be limited to the description of the embodiments contained herein.

1. A device comprising:
a ring binder having a cover that includes cardboard; and
a first bioplastic sheet that entirely covers the cardboard, the bioplastic including at least one of: polylactic acid (PLA), cellulose based PH, polycaprolate (PCL), polybutyleneadipatetetephathalate (PBT), polyhydroxyalkanoate (PHA), green polyethylene (GPE), or green polyethylene terephthalate (GPET).

2. The device of claim 1, further comprising a second bioplastic sheet that covers the first bioplastic sheet.

3. The device of claim 1, wherein the first bioplastic sheet is colored or opaque;
the device further comprising a translucent, second bioplastic sheet that covers the first bioplastic sheet.

4. The device of claim 1, wherein the first bioplastic sheet is colored.

5. The device of claim 1, wherein the first bioplastic sheet is opaque.

6. The device of claim 1, further comprising a thin layer of adhesive that coats the cardboard and holds the bioplastic sheet to the cardboard.

7. The device of claim 1, further comprising:
a front of the cover and a back of the cover;
a middle spine between the front of the cover and the back of the cover; and
a ring mechanism having a plurality of bioplastic ring binder rings;
wherein the ring mechanism is mounted on the middle spine so that the front of the cover and the back of the cover fold against generally opposite sides of the rings when the device is closed.

8. The device of claim 1, further comprising:
a front of the cover and a back of the cover; a middle spine between the front of the cover and the back of the cover; and a ring mechanism having a plurality of bioplastic ring binder rings;
wherein the ring mechanism is mounted on the back of the cover so that the middle spine folds against a side of the rings and the front of the cover folds against a top of the rings when the device is closed.

9. The device of claim 1, further comprising a sheet protector for the binder, the protector including PLA, PH, PCL, GPE, or GPET.

10. The device of claim 1, further comprising:
a bioplastic middle spine on the cover;
a plurality of bioplastic rings mounted on the middle spine; and
a bioplastic sheet protector having a left lateral tab and a plurality of apertures in the tab that align with the rings.

11. The device of claim 1, further comprising a divider for the binder that includes an Eco Friendly Material substantially consisting of PLA, PHA, PH, PCL, PBT, GPE, or GPET.

12. The device of claim 1, wherein the first plastic sheet substantially consists of PLA.

13. The device of claim 1, wherein the first plastic sheet substantially consists of cellulose based PH.

14. The device of claim 1, wherein the first plastic sheet substantially consists of PCL.

15. The device of claim 1, wherein the first plastic sheet substantially consists of PBT.

16. The device of claim 1, wherein the first plastic sheet substantially consists of PHA.

17. The device of claim 1, wherein the first plastic sheet substantially consists of GPE.

18. The device of claim 1, wherein the first plastic sheet substantially consists of GPET.

19. The device of claim 1, further comprising a plasticizer.

20. A device comprising:
a ring binder having a cover that includes cardboard;
a first, colored or opaque bioplastic sheet that entirely covers the cover and includes a bioplastic resin containing a plasticizer and at least one of: polylactic acid (PLA), cellulose based PH, Polycaprolate(PCL), Polybutyleneadipatetetephathalate(PBT), Polyhydroxyalkanoate(PHA), green polyethylene(GPE), or green polyethylene terephthalate (GPET);
a second, translucent bioplastic sheet that includes the bioplastic resin;
a middle spine;
a plurality of degradable rings mounted on the middle spine so that the cover folds against the rings;
a divider for the binder that includes the bioplastic resin; and
a sheet protector that includes the bioplastic resin that has a left lateral tab and a plurality of apertures in the tab that align with the rings.

21. The device of claim 20, wherein the degradable rings include a bioplastic resin.

22. The device of claim 20, further comprising a plasticizer.

23. The device of claim 20, wherein the spine includes one of PLA, PHA, PH, PCL, PBT, GPE, or GPET, intermixed with a plasticizer.

24. A method of making a degradable ring binder, comprising:
providing a continuous piece of cardboard;
providing a first, clear or translucent substantially bioplastic sheet, the bioplastic including a plasticizer and at least one of: polylactic acid (PLA), cellulose based PH, Polycaprolate (PCL), Polybutyleneadipatetetephathalate (PBT), polyhydroxyalkanoate (PHA), green polyethylene (GPE), or green polyethylene terephthalate (GPET);
coating the cardboard with a thin layer of adhesive that will hold the bioplastic;
laying the bioplastic sheet over the cardboard so that the sheet covers the cardboard, thereby providing a binding cover;
providing a degradable ring mechanism; and
attaching the ring mechanism to the bind cover.

25. The method of claim 24, further comprising:
pressing and cutting the sheet of bioplastic around edges of said sheet, thereby creating a permanent peripheral seal and a foldable seal around the middle spine;
utilizing a series of rollers to press over the top of the cardboard, smoothing out the plastic and ensuring it has a strong seal;
mechanically adding the binder rings; and
mounting the spine of the binder to a left lateral margin of a back of the cover of the binder by pressing a series of pins to permanently attach the bar.
